(19) United States
(12) Patent Application Publication
(10) Pub. No.: US 2010/0086048 A1
(43) Pub. Date: Apr. 8, 2010

(54) System and Method for Video Image Processing

(76) Inventors: Faisal Ishtiaq, Chicago, IL (US); Shih-Ta Hsiang, Schaumburg, IL (US); Zhu Li, Palatine, IL (US); Tony May, Winchester (GB)

Correspondence Address: WHYTE HIRSCHBOECK DUDEK S C;INTELLECTUAL PROPERTY DEPARTMENT, 555 EAST WELLS STREET, SUITE 1900, MILWAUKEE, WI, 53202, US

(21) Appl. No.: 12/245,355

(22) Filed: Oct. 3, 2008

(51) Int. Cl. H04N 7/12

(52) U.S. Cl. 375/240.16; 375/E07.076

(57) ABSTRACT

A system for processing video imaging information, corresponding electronic device, and method of processing video imaging information, are disclosed. In at least one embodiment, the electronic device includes a coder capable of compressing the imaging information for transmission via a communications channel, the video imaging information pertaining to a plurality of video source frames including a current source frame. The coder includes means for performing a super-resolution operation in relation to previous frame information representative of at least one of the video source frames occurring prior to the current source frame, the super-resolution operation being performed prior to at least some of the video imaging information corresponding to the current source frame being coded or decoded.

### CROSS-REFERENCE TO RELATED APPLICATIONS

### STATEMENT REGARDING FEDERALLY SPONSORED RESEARCH OR DEVELOPMENT

### FIELD OF THE INVENTION

The present invention relates to multimedia processing techniques and, more particularly, to systems and methods for encoding and decoding digital video.

### BACKGROUND OF THE INVENTION

Video encoding and decoding techniques are employed in a wide variety of applications, including for example, high-definition television (HD-TV), digital versatile disks (DVDs), digital cameras, medical imaging, and satellite photography among others. Frequently, such applications involve compressing large quantities of video data for transmission, as well as decompressing such video data after transmission.

Successful video encoding and decoding involves tradeoffs among disk (or other media) space, video quality, and the cost of hardware required to compress and decompress video in a reasonable amount of time. Typically, during compression of video data, image quality is reduced or otherwise compromised. After excessive lossy video compression compromises visual quality, it is often extremely difficult or potentially impossible to recover data to its original quality.

Several conventional techniques for improving the quality of compressed video data attempt to restore the quality of video subsequent to compression and transmission, and thus are often referred to as “post-processing” techniques. Although adequate for some applications, such conventional techniques nevertheless are often inadequate in achieving restoration or improvements in the resolution of video.

Given the limitations associated with conventional techniques for video encoding and decoding, it would therefore be advantageous if an improved technique for achieving efficient encoding and decoding is developed. It would additionally be advantageous if in at least some embodiments such a technique can improve the quality of video data including low resolution images without significantly affecting the compression rates.

### BRIEF DESCRIPTION OF THE DRAWINGS

FIG. 1 shows in schematic form a first video coding and broadcast system employing an encoder system in communication with a decoder system in accordance with at least some embodiments of the present invention;

FIG. 2 shows in schematic form an encoding process employed by the encoder system of the video coding and broadcast system of FIG. 1 in accordance with at least some embodiments of the present invention;

FIG. 3 shows in schematic form a decoding process employed by the decoder system of the video coding and broadcast system of FIG. 1 in accordance with at least some embodiments of the present invention;

FIG. 4 is an exemplary flowchart showing the steps of operation of the video encoding and decoding process of FIGS. 2 and 3 in accordance with at least some embodiments of the present invention;

FIG. 5 shows in schematic form an alternate encoding process employed by the encoder system of the video coding and broadcast system of FIG. 1 in accordance with at least some other embodiments of the present invention;

FIG. 6 is another exemplary flowchart showing the steps of operation of the encoder system of FIG. 5 in accordance with at least some embodiments of the present invention;

FIG. 7 shows in schematic form displacement of pixels from one frame to another frame in accordance with at least some embodiments of the present invention; and

FIG. 8 shows in schematic form a second video coding and broadcast system employing a first video coding device in communication with a second video coding device in accordance with at least some embodiments of the present invention.

### DETAILED DESCRIPTION

The present invention addresses the above-described limitations associated with conventional techniques for encoding/decoding of video imaging information, and focuses on enhanced video image processing by a new system or electronic device (and/or associated method of operation) that implements a super-resolution operation in combination with the process of coding the video imaging information. In at least some embodiments, for example, the electronic device includes an encoder capable of compressing the video imaging information into a video bit stream that performs a super-resolution operation within the interpolation process. Additionally, in some other embodiments, the electronic device includes a decoder capable of decoding the compressed video information output from the encoder and capable of performing super-resolution based interpolation within the interpolation process.

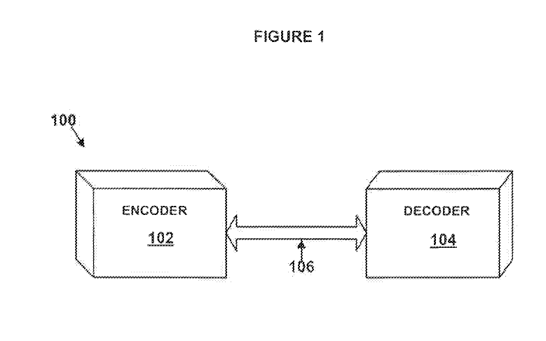

Referring more particularly to FIG. 1, an exemplary video coding and broadcast system 100 is shown in a simplified schematic form in accordance with at least some embodiments of the present invention. As shown, the video broadcast system 100 includes an encoder system 102 in communication (e.g., broadcast mode) with a decoder system 104 via a channel 106. Typically, raw video signal information received by the encoder system 102 is encoded/compressed to produce a video signal that is transmitted through the channel 106 to the decoder system 104. The raw video signal information can vary depending upon the embodiment and can include information received via any of a variety of different types of communication media from any of a variety of different types of signal sources including, for example, satellite, cable, radio frequency (RF) or the internet. Upon receiving the compressed video signal, the decoder system 104 in turn produces a decoded/decompressed video signal that can then be used for a variety of purposes or provided to a variety of different devices, again by way of any of a variety of communications media.

The encoder and the decoder systems 102 and 104 respectively, can be any of a variety of hardware devices that, by themselves or in combination with software, are capable of handling, processing, and communicating video signals over the channel 106. Similarly, the channel 106, which facilitates communication between the encoder system 102 and the decoder system 104 is also intended to be representative of any of a wide variety of different possible communication links including, for example, various data transfer media and/or interfaces, including both wired (e.g., landline) or wireless network interfaces, and additionally links involving the internet or the World Wide Web. In other embodiments, communication links/media other than those mentioned above can be employed as well.

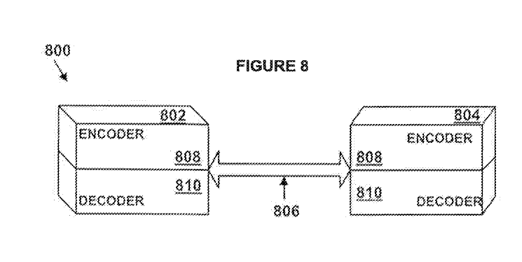

Although the video coding and broadcast system 100 of FIG. 1 includes merely a single encoder system and a single decoder system, it will be understood that in other embodiments the video coding and broadcast system can include multiple encoder and decoder systems that are in communication with one another. Also, while the video coding and broadcast system 100 of FIG. 1 includes separate encoder and decoder systems, in other embodiments each of the different systems that are in communication with one another can have both an encoder system and a decoder system, as discussed below in regards to FIG. 8.

Further, in alternate embodiments, the compressed (or decompressed) signals communicated by way of the channel 106 or otherwise provided/received by the respective encoder and the decoder systems 102, 104 (or other such devices) can additionally be sent to an external device, for purposes such as storage and further processing. Additionally, although not shown, it will be understood that a variety of other systems and components including, for example, filters, memory systems, processing devices, storage units, etc., can be provided in conjunction with, or as part of, one or both of the encoder and the decoder systems 102 and 104, respectively.

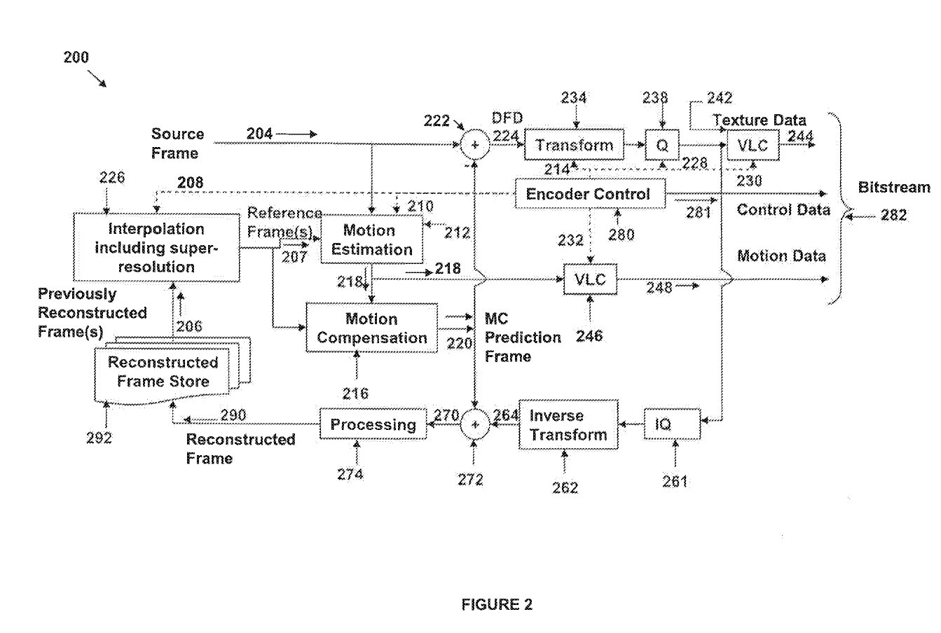

Referring now to FIG. 2, an exemplary motion compensated discrete cosine transform (MC-DCT) based encoder system 200 is shown in a simplified schematic form, in accordance with at least some embodiments of the present invention. The encoder system 200 in at least some respects is representative of a video encoder that satisfies the requirements of the H.263, MPEG-4, and H.264 video coding standards. Compression within the encoder system 200 is accomplished by dividing a video stream into a sequence of video frames, each of which is compressed individually within the encoder. A source frame 204 from the sequence of video frames is typically compressed by operating on a group of pixel data that is often referred to as a macroblock (e.g., a block of 16×16 pixels).

Generally speaking, during the compression process, the input source frame 204 is compared with one or more reference frame(s) 207 within a motion estimation module 212. The motion estimation module 212 performs a motion estimation operation to estimate the motion of individual or groups of pixels within macroblocks between the source and the reference frames 204 and 207 respectively, to generate displacement vector information, also referred to as motion vectors (MV) 218. The motion vectors 218 are then provided to a motion compensation module 216, which utilizes the motion vector information to compensate the one or more reference frame(s) 207 to create a prediction frame, referred to as a motion compensated prediction frame 220. The motion vectors 218 are additionally input to a variable length coded (VLC) module 246 to produce compressed motion vectors 248, which is a compact representation of the motion vector information in a lossless manner that is transmitted along with the compressed video signal to the decoder system 104 (see FIG. 1).

Upon being output by the motion compensation module 216, the motion compensated prediction frame 220 is then subtracted from the source frame 204 in a subtraction module 222 to obtain a displaced frame difference (DFD) 224 (also referred to as the motion compensated frame residual error). Typically, the smaller the DFD 224, the greater is the compression efficiency. A smaller DFD 224 is normally obtained if the motion compensated prediction frame 220 bears a close resemblance to the source frame 204. This, in turn, is dependent upon the accuracy of the motion estimation process performed within the motion estimation module 212. Thus, accurate motion estimation is important for effective compression.

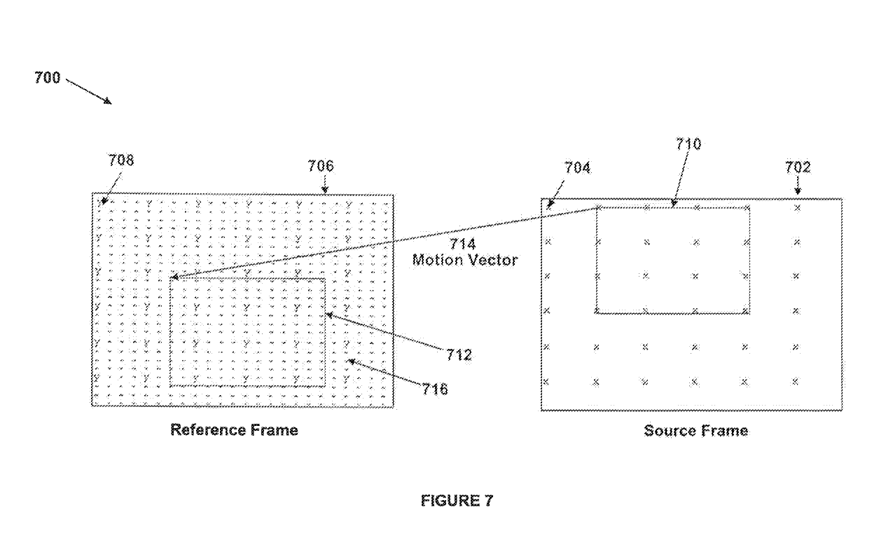

With respect to motion estimation in particular, such techniques often attempt to capture the displacement of pixels in the source frame from the reference frame. The displacement of pixels is typically captured in the form of a vector from the source pixel values to pixel locations in the reference frame. Due to discrete time differences between the time the source and reference frames are captured and the discrete sampling distances between adjacent pixel values within the video frames, often accurate motion categorizing of the displacement of the source pixels does not point to an actual, or integer, full pixel value in the reference frame. Rather, it is likely that the motion vector will point to a location in the reference frame that is located at sub-pixel (sub-pel) data values, or in other words between two actual, or integer, pixel data values, as shown in FIG. 7.

Referring now to FIG. 7 in conjunction with FIG. 2, an exemplary displacement 700 of pixel data values of a source frame 702 with pixels 704 (represented respectively by the letter x) from a reference frame 706 with pixels 708 (represented respectively by the letter y) is illustrated in a figurative manner. Also shown is a block of pixels 710 in the source frame 702 and an accurate location 712 of the block of pixels 710 within the reference frame 706. The displacement information relating the block of pixels 710 to the location 712 in the reference frame 706 is shown by a motion vector 714. Of particular note is that FIG. 7 depicts a scenario typical of the majority of natural motion between two video frames, where the displacement is from locations within the reference frame 706 that are not at integer data values but rather between the full pixel locations. It is therefore beneficial to have pixel information located more densely within the reference frame 706 so as to have more accurate values at positions in between integer pixels values.

In view of the above considerations, in order to provide more accurately displaced pixel data, a technique known as interpolation is employed to increase the spatial resolution of reference frames such as the reference frames 706 and the reference frame(s) 207 (specifically, FIG. 7 shows an interpolation process by a factor of 4 in which interpolated “sub-pixel” values 716 represented respectively by the symbol ‘-’ lie between the integer pixel values 708). Referring particularly back to FIG. 2, the increase in spatial resolution achieved by way of interpolation more particularly can be accomplished by calculating such “sub-pixel” or intermediate values or locations between the integer pixel locations through the use of an interpolation module 226. These intermediate values or locations more particularly allow motion estimation to be accomplished with a technique known as sub-pel motion estimation. The effect of sub-pel motion estimation in increasing compression efficiency has prompted all MC-DCT video standards since MPEG-2 to standardize this technique.

Typically, interpolation for the purposes of sub-pel motion estimation is accomplished by a process of filtering one or more previously reconstructed frame(s) 206 to form the one or more reference frame(s) 207. That is, the interpolation module 226 includes one or more filters, and interpolation using the filters is accomplished with filter designs that are able to accurately provide sub-pixel data points while minimizing any alterations to the pixel values at the integer positions, thereby keeping original pixel values at those locations. These filters are exactingly specified within standards such as MPEG-2, MPEG-4, H.263, and H.264.

Notwithstanding the advantages of interpolation by filtering operations to increase the spatial resolution and improve the compression rate of a video stream, interpolation by itself is unable to improve the quality of the reference frame(s) 207 if the previously reconstructed frame(s) 206 upon which interpolation is performed to generate those reference frames are of low resolution. For example, if the previously reconstructed frame(s) 206 result in a series of low resolution, blurry frames having a variety of artifacts, interpolation typically does not operate to improve the quality of these frames once they are interpolated into the reference frame(s) 207. Thus, at least some embodiments of the present invention employ an alternate interpolation mechanism based upon a super-resolution technique that is performed within the interpolation module 226. By virtue of performing a super-resolution process, higher quality and higher resolution reference frames can be obtained from a set of multiple lower resolution previously constructed frames.

Generally speaking, super-resolution is a well established mathematical process that has traditionally been cast as a restoration process, as provided in “Super-Resolution Image Reconstruction: A Technical Overview” (IEEE Signal Processing Magazine, May 2003), the entirety of which is incorporated by reference herein. The restoration process typically includes three broad stages of processing encompassing registration (motion estimation), interpolation to a larger resolution, and restoration to remove any artifacts such as blurring. The restoration process in particular is applied by utilizing several of the previously reconstructed frame(s) 206 to form higher resolution, higher quality, reference frame(s) 207 for the purposes of improved motion estimation at a sub-pixel level. That is, in view of the above discussion, the reference frame(s) 207 output from the interpolation module 226 are high-resolution interpolated frame(s) that typically draw upon more than one of the previously reconstructed frame(s) 206 (albeit sometimes the interpolation will draw upon a single one of the previously reconstructed frames).

As will be described in further detail below, in at least some embodiments, super-resolution can be performed in addition to one or more other interpolation methods as part of the overall interpolation process within the interpolation module 226. That is, the reference frame(s) 207 generated by the interpolation module 226 in the encoder system 200 are generated by way of the processes of super-resolution and/or filtering utilizing the respective previously reconstructed frame(s) 206. Any of a variety of known approaches can be employed by the interpolation module 226 to perform super-resolution. These can include super-resolution techniques that involve frequency or space domain algorithms, techniques that utilize aliasing information, techniques that extrapolate image information in the frequency domain, techniques that break the diffraction-limit of systems, techniques that are suitable for diffraction-limited systems (or techniques where the total system modulation transfer function is filtering out high-frequency content), and/or techniques that break the limit of a digital imaging sensor used to generate the imaging information. In general, the application of any of these super-resolution techniques increases the resolution of the ultimate reference frame(s) 207 by utilizing multiple lower resolution previously reconstructed frame(s) 206 that have sub-pixel shifting among them.

Upon performing interpolation within the interpolation module 226 to generate the reference frame(s) 207, sub-pel motion estimation, and compensation are performed within the motion estimation module 212 and motion compensation module 216, respectively, to obtain the motion compensated prediction frame 220. The motion compensated prediction frame 220, as discussed above, is then subtracted from the source frame 204 to obtain the displaced frame difference (DFD) 224. The DFD 224 is further compressed within the encoder system 200 by transforming the DFD into a secondary representation within a transform module 234. The DFD 224 transformed within the transform module 234 is additionally quantized within a quantization (Q) module 238. Subsequent to quantization, the quantized values are input into a variable length coding (VLC) module 242 which, in turn, outputs a compact representation of the quantized values 244, also known as texture data.

The variable length coded quantized values 244, the compressed motion vectors 248, and any associated control information 281 generated by an encoder control module 280 are then multiplexed into a video bit stream 282. The encoder control module 280 in particular is responsible for generating administrative data necessary within the video bit stream for accurate reconstruction of the video from its compressed representation. The encoder control module 280 additionally controls the operation of each of the interpolation, motion estimation, transform, Q, and VLC modules 226, 212, 234, 238, 242, and 246, respectively, as shown by respective dashed lines 208, 210, 214, 228, 230, and 232. The predictive nature of the encoder system 200 requires it to also generate the previously reconstructed frame(s) 206 such that subsequent source frames can be encoded by utilizing the previously reconstructed frame(s). This is accomplished in the encoder system 200 by performing an inverse quantization of the quantized values produced by the Q module 238 in an inverse quantization (IQ) module 261 and subsequently performing an inverse transformation of the de-quantized values in an inverse transform module 262.

The output of the inverse transform module 262 is a reconstructed displaced frame difference (DFD) 264, which is then combined with the motion compensated prediction frame 220 in a summation module 272 to produce a decoded frame 270. In at least some embodiments as shown, the decoded frame 270 is further processed by a processing module 274 to generate a reconstructed frame 290. For example, in at least some embodiments, the processing module 274 can be a de-blocking filter as employed within the H.264 video standard, although in other embodiments, other types of processing modules can be employed. Subsequent to the generating of each of the reconstructed frames 290, each such frame is stored within a reconstructed frame store 292. The reconstructed frame 290 can in turn be obtained from the frame store 292 and utilized as the previously reconstructed frame(s) 206 for the encoding of subsequent source frames 204. The number of the reconstructed frames 290 that are stored (or capable of being stored) at any given time is dependent upon a standard and/or the implementation of the encoder system 200.

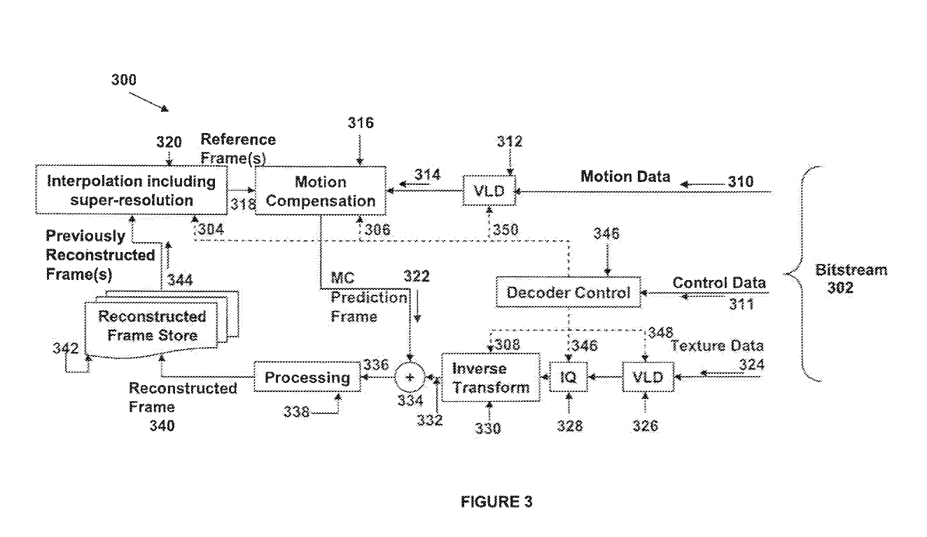

Turning now to FIG. 3, an exemplary video decoder system 300 capable of decoding a video bit stream 302 (which in at least some embodiments can be the bit stream 282 output by the encoder system 200 in FIG. 2) is shown in accordance with at least some embodiments of the present invention. The decoder system 300, which is similar in some respects to the encoder system 200, is in at least some respects representative of MC-DCT decoders appropriate for satisfying the requirements of the MPEG-2, MPEG-4, and H.264 video standards. As shown, the decoding operation is performed by decoding several types of data received by the decoder system 300 and contained in the video bit stream 302, namely, motion data 310, control data 311, and texture data 324. Generally speaking, in order for the decoder system 300 to accurately reconstruct the encoded video produced by the encoder system 200, the processing elements of the decoder are designed to match (or constitute the inverse of) the operations carried out in the encoder, particularly for those operations that are common between the encoder and decoder, in at least some respects.

With reference to the motion data 310 in particular, it is first processed by a variable length decoder (VLD) 312 to regenerate motion vectors 314. The motion vectors 314 are similar (or substantially similar) to the motion vectors 218 originally generated within the encoder system 200 by the motion estimation module 212. The motion vectors 314 are then input to a motion compensation module 316, which again is identical (or substantially identical) to the motion compensation module 216 of the encoder system 200. The operation of the motion compensation module 316 utilizes one or more reference frames 318 and the motion vectors 314 to generate a motion compensated prediction frame 322. Similar to the encoding process, the one or more reference frames 318 utilized in the decoder for decoding are generated by utilizing one or more previously reconstructed frame(s) 344 acquired from a reconstructed frame store 342.

Additionally, similar to the encoding process performed by the encoder system 200, in the present embodiment the decoding process performed by the decoder system 300 involves an interpolation module 320 that performs interpolation based upon one or more of the previously reconstructed frame(s) 344 to generate the reference frames 318. Further, to accurately reconstruct the video stream, the interpolation module 320 is identical (or substantially identical) to the interpolation module 226 of the encoder system 200, although this may vary depending upon the embodiment. Typically, and as discussed above, interpolation is accomplished by a process of filtering one or more of the previously reconstructed frame(s) 344 to form the one or more reference frames 318 to increase the spatial resolution and improve the compression rate of a video stream. However, to improve upon the quality of the previously reconstructed frame(s) 344 having lower resolution, a super-resolution based interpolation process can further be performed by the interpolation module 320 that generates the higher quality and higher resolution reference frames 318 from more than one of the lower resolution previously reconstructed frames 344.

Referring still to FIG. 3, to reconstruct the video stream, the texture data 324 (e.g., the texture data (quantized values 244) from the encoder system 200) is first processed by a variable length decoding (VLD) module 326 and then inverse quantized in an inverse quantization (IQ) module 328. The IQ module 328 is similar to the IQ module 261 of the encoder system 200. The inverse quantized data is then processed by an inverse transform module 330 to generate a reconstructed displaced frame difference 332. Once the reconstructed displaced frame difference 332 and the motion compensated prediction 322 have been generated, they are combined by a summation module 334 to generate a decoded frame 336.

The decoded frame 336 can then be processed by an additional processing module 338 to generate a reconstructed frame 340. In at least some embodiments including, for example, embodiments following the H.264 video standard, the processing module 338 can be a deblocking filter. Nevertheless, in other embodiments, other types of processing modules and associate operations can be employed. Assuming that the video bit stream 302 received by the decoder system 300 is the same as the video bit stream 282 generated by the encoder system 200, each of the reconstructed frames 340 is respectively identical (or substantially identical) to a corresponding one of the reconstructed frames 290 generated by the encoder system 200. Regardless of whether this is the case, as the reconstructed frames 340 are generated by the decoder system 300, they are stored in a reconstructed frame store 342. One or more of the reconstructed frames 340 can be stored within the reconstructed frame store 342 at any point in time.

The decoding process described above is generally performed under the control of a decoder control module 346, which is responsible for generating administrative data as governed by (or in response to) the information contained within the control data 311, so as to accurately reconstruct the video stream from the compressed representation received from the encoder system 200. The administrative data generated by the decoder control module 346 in turn is employed for controlling the operation of each of the interpolation, motion compensation, inverse transform, IQ and VLD modules 320, 316, 330,328, 326, and 312 respectively, as shown by respective dashed lines 304, 306, 308, 346, 348, and 350.

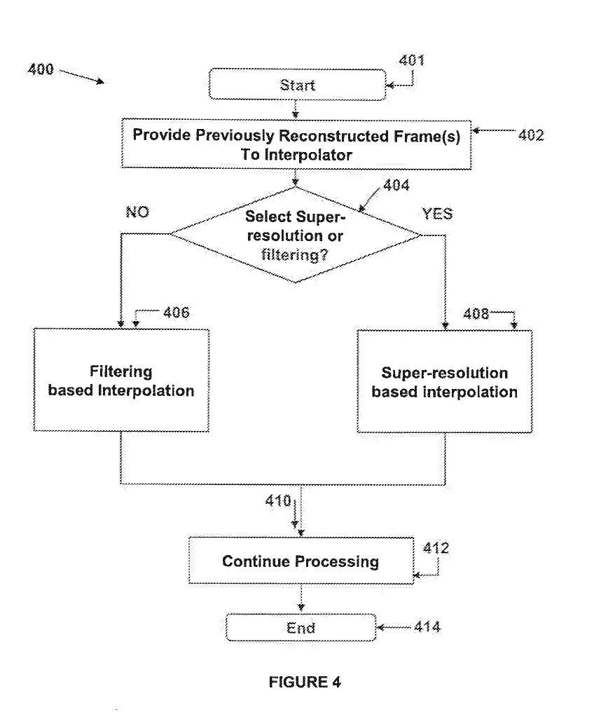

Turning now to FIG. 4, a flowchart 400 shows exemplary steps of operation of each of the interpolation module 226 and the interpolation module 320 within the encoder system 200 and the decoder system 300, respectively, in accordance with at least some embodiments of the present invention. As discussed below, in at least some embodiments, the interpolation process need not always perform super-resolution or filtering, but rather can switch between performing either one of those operations. More particularly as shown, upon starting at a step 401, the process proceeds to a step 402 where previously reconstructed frame(s) (e.g., the previously reconstructed frame(s) 206 from the encoder system 200 or the previously reconstructed frame(s) 344 from the decoder system 300) are provided to the interpolation module (again, e.g., either of the interpolation modules 226, 320). Next, at step 404, a decision as to whether interpolation will be performed using super-resolution or filtering is made by the interpolation module.

Typically, a decision to use either filtering or super-resolution for interpolation at the step 404 is made prior to the actual process of interpolation carried out in steps 406 or 408. The selection between filtering and super-resolution for interpolation can be based upon one or more criteria, some of which are described below. For example, in at least some embodiments, the decision between filtering and super-resolution can be based upon whether more than a predefined number of previously reconstructed frame(s) have been generated and are available in the reconstructed frame store (e.g., the reconstructed frame store 292 or the reconstructed frame store 342). Relatedly, availability of computational resources to perform super-resolution utilizing the previously reconstructed frame(s), or a determination that the resolution of the source video is above a certain threshold in either of the horizontal or vertical directions, can constitute other criteria for selecting super-resolution over filtering or vice-versa. Another factor upon which the determination can be based is whether the source frame (e.g., the source frame 204) is to be encoded/decoded as an inter coded (P) frame utilizing motion estimation and compensation within the encoder/decoder. In other embodiments, other criteria can be employed for selecting between super-resolution and filtering for interpolation.

If super-resolution based interpolation is to be performed, the process then advances to the step 408, in which interpolation via super-resolution is performed (by way of the interpolation module). If instead super-resolution is not to be performed and filtering is selected, the process advances from the step 404 to the step 406, at which interpolation is performed by the interpolation module using typical methods of filtering. Switching between filtering and super-resolution based interpolation can be performed by the interpolation module if that device is capable of being switched between a filtering based interpolation operation and interpolation with super-resolution, or by an additional interpolator (not shown) coupled to receive the previous frames and to provide reference frames as output.

In the present embodiment in which both filtering and super-resolution can be performed by each of the interpolation modules 226, 320, the encoder system 200 and the decoder system 300 each achieve added flexibility insofar as this capability of performing either type of interpolation allows an operator/provider to specify whether to use filtering or super-resolution based interpolation. The choice(s) made at the encoder system 200 and/or the decoder system 300 as to whether filter-based interpolation or interpolation with super-resolution will be performed can be explicitly indicated by way of entering representative information bits within the bit stream or implicitly with a sequence of processes identical for both the encoder control module 280 and decoder control module 346. Subsequent to performing either filter-based interpolation at the step 406 or super-resolution based interpolation at the step 408, the output from those steps is one or more reference frames 410 (e.g., one or more of the reference frame(s) 207 in the encoder system 200 or one or more of the reference frames 318 in the decoder system 300), which is/are provided. Subsequently, the process proceeds from either of the steps 406, 408 to a step 412 for further encoding or decoding of the video subject to the interpolation process being located in the encoder or decoder. The process then ends at a step 414.

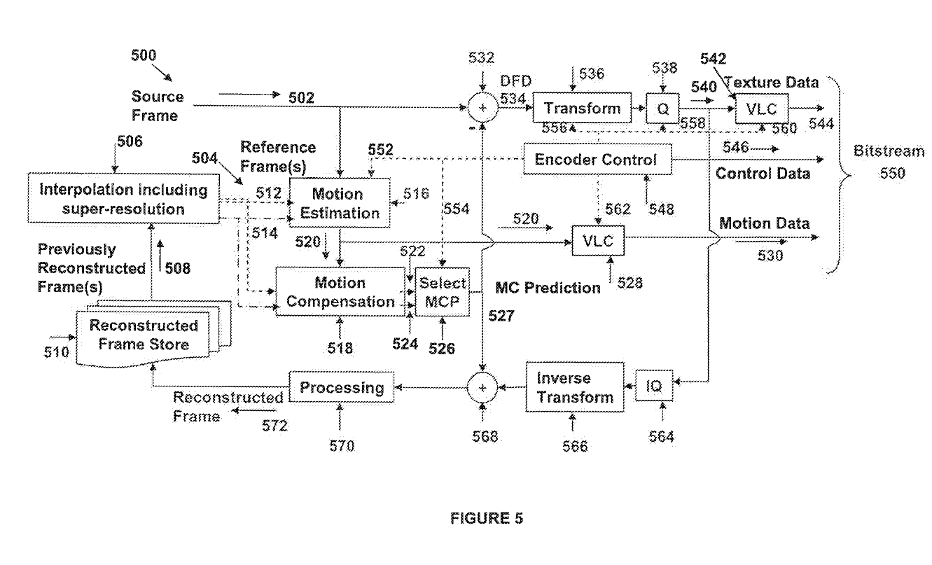

Referring now to FIG. 5, an additional encoder system 500 in accordance with an alternate embodiment is shown in schematic form. Similar to the encoder system 200 of FIG. 2, in the encoder system 500 a source frame 502 is compared with one or more reference frames 504 as part of an overall process of generating a compressed video signal. Particularly, with respect to the one or more reference frames 504, these frames are generated by performing an interpolation process within an interpolation module 506 based upon one or more previously reconstructed frame(s) 508 selected from a reconstructed frame store 510. However, in contrast to the encoder system 200 of FIG. 2, for added flexibility, the interpolation module 506 of the encoder system 500 performs both of the filtering and super-resolution based interpolation operations to output respective sets of reference frames 512 and 514 for each of those operations. That is, in contrast to the one set of reference frame(s) 207 developed within the encoder system 200, the encoder system 500 develops two sets of the reference frames 504, namely, the reference frames 512 generated by way of filtering and the reference frames 514 generated by way of super-resolution.

The reference frames 512 and 514 are then input into motion estimation and motion compensation modules 516 and 518, respectively. The motion estimation module 516 generates motion vectors 520 based upon the reference frames 504, while the motion compensation module 518 produces two sets of motion compensated prediction frames 522 and 524 corresponding to the two sets of reference frames 512 and 514, respectively, for each of the filtering and the super-resolution based interpolation. As shown, the motion compensated prediction frames 522 and 524 are generated by utilizing the motion vectors 520 estimated by the motion estimation module 516 in addition to the reference frames 504.

Upon being generated by the motion compensation module 518, the motion compensated prediction frames 522 and 524 are in turn provided to a select motion compensation prediction (select MCP) processing module 526, which serves to select between the filtering and super-resolution based interpolation techniques for generating a compressed video signal. Particularly, upon selecting between the filtering and super-resolution based interpolation techniques, the select MCP processing module 526 selects the motion compensated prediction frames 522 or 524 that were developed by way of the selected interpolation technique and outputs the selected frame(s) as one or more selected motion compensated prediction frame 527. Additionally, the selecting between the filtering and super-resolution based interpolation techniques also determines whether the motion vectors 520 output by the motion estimation module 516 are based upon the reference frames 512 or 514. Thus, not only are the appropriate ones of the motion vectors 520 supplied to the motion compensation module 518, but also the appropriate ones of the motion vectors 520 associated with the selected set of reference frames are output to a video bit stream 550 along with the choice of interpolation (filtering or super-resolution) via a VLC module 528 as compressed motion vectors 530.

Also as shown in FIG. 5, upon the select MCP processing module 526 outputting a given one of the selected motion compensated prediction frame 527 in response to the arrival of the source frame 502, that given one of the selected motion compensated prediction frames is then subtracted from the source frame in a subtraction module 532 so as to generate a displayed frame difference (DFD) 534. The DFD 534 is then transformed and quantized in transform and quantization (Q) modules 536 and 538, respectively, to generate a quantized DFD 540. The quantized DFD 540 is subsequently input into a VLC module 542 to generate a compressed video signal or texture data 544. The texture data 544, the compressed motion vectors 530, and any associated control information 546 generated by an encoder control module 548 is multiplexed so as to form the overall video bit stream 550 allowing for reconstruction of the video in a decoder. Similar to the encoder control module 280, the encoder control module 548 controls the operation of the motion estimation, select MCP processing, transform, Q, and VLC modules 516, 526, 536, 538, 528, and 542, as shown by dashed lines 552, 554, 556, 558, 560, and 562.

Further, to allow for the encoding of additional source frames, the quantized DFD 540 is inverse quantized and inverse transformed in inverse quantization (IQ) and transform modules 564 and 566, respectively, and the result is combined with the selected motion compensated prediction frame 527 in a summation module 568. Upon adding these two components, the summation module 568 outputs the sum to a processing block 570, which performs processing and results in a reconstructed frame 572, which is stored in the reconstructed frame store 510 for use in performing additional interpolation to produce subsequent reference frames. Additionally, although not shown, it will be understood that a decoder suitable for receiving and decoding the video bit stream 550 from the encoder system 500 can be substantially similar to the decoder system 300 with the exception of its interpolation module and the inclusion of an additional select MCP processing module. More particularly, the interpolation module of such a decoder performs both filtering and super-resolution based interpolation techniques to output two sets of reference frames, resulting in two sets of motion compensated prediction frames. The select MCP processing module in turn selects between corresponding motion compensated reference frames from the two sets of such reference frames based upon the choice of interpolation information received as part of the received video bit stream, thus allowing for proper decoding of the compressed video.

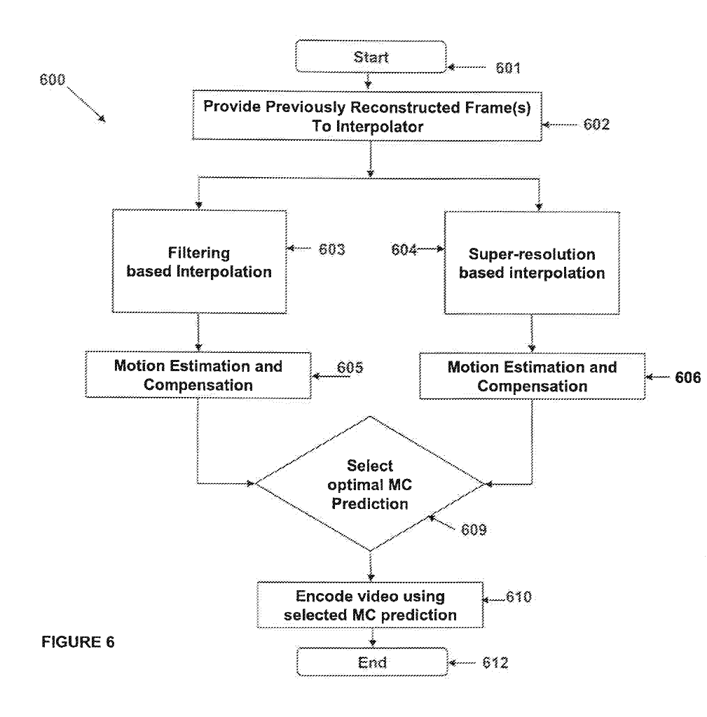

Turning now to FIG. 6, a flowchart 600 shows exemplary steps of operation of the encoder system 500 of FIG. 5, particularly as it relates to selecting between super-resolution and filtering based interpolation. As shown, the process starts at a step 601 and proceeds to a step 602 in which the previously reconstructed frame(s) 508 are input into the interpolation module 506. Next, both filtering-based interpolation and super-resolution based interpolation processes are performed simultaneously or substantially simultaneously within the interpolation module 506, as indicated by steps 603 and 604, respectively. Notwithstanding the fact that two separate steps of filtering and super-resolution based interpolation are shown, it should be understood that in at least some embodiments both of those techniques are performed within a single interpolation module.

The output of the filtering based interpolation performed in the step 603 is the first set of reference frames 512 and the output of the super-resolution based filtering at the step 604 is the second set of reference frames 514. The respective reference frames 512, 514 of the two sets respectively produced in steps 603, 604 are in turn provided to the motion estimation and compensation modules, at which those reference frames are subsequently processed by motion estimation and motion compensation processes, as indicated by the steps 605 and 606, respectively. The outputs of the processes performed at the steps 605 and 606 are the two sets of the motion compensated prediction frames 522 and 524, respectively.

Next, at a step 609, those motion compensated prediction frames are input into the select MCP processing module 526, which selects one of the motion compensated prediction frames as best for the purposes of encoding the source frame. Criteria that can be employed in selecting between the two motion compensated frames can include one or a combination of the resemblance of the motion compensated prediction frame with the source frame, and the number of motion vectors generated by the motion compensation processes performed in the steps 605, 606 in relation to the reference frames generated by the different types of interpolation (e.g., typically a fewer number of motion vectors is preferred). Subsequent to selecting one of the motion compensated prediction frames 522, 524, the process advances to a step 610, at which the encoding process continues to generate a compressed video signal based upon the selected motion compensation prediction frame 527. The process ends at a step 612 upon generating the compressed video signal.

Turning now to FIG. 8, an alternate embodiment of an exemplary video coding and broadcast system 800 is shown in a simplified schematic form in accordance with at least some embodiments of the present invention. In general, the components of the video coding and broadcast system 800 are substantially similar to the video coding and broadcast system 100 of FIG. 1. However, in contrast to the video coding and broadcast system 100 of FIG. 1 in which the encoder system 102 and the decoder system 104 are separate systems in communication via the channel 106, the video coding and broadcast system 800 employs two devices in communication with one another, with each device having both an encoder system and a decoder system.

More particularly, as shown, the video coding and broadcast system 800 includes a first video coding device 802 in communication with a second video coding device 804 via a channel 806. The first and the second video coding devices 802 and 804, respectively can be any of a variety of hardware devices that, by themselves or in combination with software, are capable of handling, processing, and communicating video signals over the channel 806. Notwithstanding the fact that the video coding and broadcast system 800 is referred to as a video “coding” and broadcast system and notwithstanding the fact that the first and the second video coding devices 802, 804 are referred to as “coding” devices, it will be understood that each of those devices is capable of both encoding video signals for transmission over the channel 806 and decoding video signals received via that channel. Indeed, in the present embodiment, each of the first and the second video coding devices 802, 804 is a respective “codec” device including both a respective encoder system 808 for compressing a video stream, and a respective decoder system 810 for decompressing the compressed video stream back into the original video.

With respect to video coding in particular, raw video signal information is received by the encoder system 808 of one (either one) of the first and the second video coding devices 802, 804. Upon receiving the raw video signal information, the encoder system 808 produces an encoded/compressed video signal to be transmitted through the channel 806 to the decoder system 810 of the other of the first and the second video coding devices 802, 804. The decoder system 810 in turn produces a decoded/decompressed video signal that can then be used for a variety of purposes or provided to a variety of different devices, by way of any of a variety of communications media, as discussed above.

Further, although the video coding and broadcast system 800 includes merely the first and the second video coding devices 802 and 804, it will be understood that in other embodiments the system can include more than two devices that are in communication with one another. Indeed, notwithstanding the fact that in the present embodiment each of the first and the second video coding devices 802, 804 is a codec device, in other embodiments other types of video communication and processing devices can be employed as well. Further, in alternate embodiments, the compressed (or decompressed) signals communicated by way of the channel 806 or otherwise provided/received by the first and the second video coding devices 802, 804, respectively (or other such devices) can additionally be sent to an external device, for purposes such as storage and further processing. Additionally, although not shown, it will be understood that a variety of other systems and components including, for example, filters, memory systems, processing devices, storage units, etc., can be provided in conjunction with, or as part of, one or both of the first and the second video coding devices 802 and 804, respectively.

In view of the above description, therefore, it can be seen that the video coding and broadcast systems 100 and 800 are capable of taking any arbitrary number of source frames and compressing those source frames by way of both spatial compression and temporal compression for transmission over a channel. Additionally, the video coding and broadcast systems 100 and 800 are further capable of receiving information representative of any arbitrary number of source frames and decompressing those source frames by way of both types of compression to arrive back at the source frames (or at least close approximations of the original source frames). In particular, both the coding and decoding can involve temporal compression/decompression that employs both filtering and super-resolution based interpolation operations.

The operation of the encoder systems 200 and 500 described above can generally be considered to include temporal or “inter-frame” compression, insofar as the above-described operations attempt to identify and take advantage of similarities among neighboring frames to perform compression. In addition to performing temporal compression, the encoder systems 200 and 500 are also able to perform spatial or “intra-frame” compression, in which operations are performed to identify and take advantage of similarities among different pixels/regions within each given frame to perform compression. This is done without capitalizing on the temporal similarities. Similar (albeit inverted) capabilities are also present in the decoder system 300.

In view of the above discussion, it should be apparent that at least some embodiments of the present invention augment a system and method for compressing and decompressing video data. Advantageously, the system and method provide a technique and, more particularly, a super-resolution based interpolation technique for achieving high compression rates with little or no negative impact upon the visual quality. Insofar as super-resolution based interpolation for improving the visual quality of video data can be implemented during the encoding and decoding processes, any additional time for improving the quality of data in any post-processing steps is also avoided.

Although the discussion above relating to FIGS. 1-8 sets forth certain exemplary embodiments of video coding (and decoding) systems and methods, other embodiments and refinements including additional features are contemplated and considered with the scope of the present invention. For example, while the use of discrete cosine transformation is discussed above (e.g., in connection with the transformation performed by transform modules such as the transform module 234 of FIG. 2), in other embodiments other types of transformations, such as wavelet transformations, are also possible. Further, although it has been assumed above that at least some of the various modules operate substantially similarly in both the encoder and the decoder by employing substantially similar approaches, this may need not always be the case in other embodiments. Rather, each one of the modules can have different implementations and different designs.

Embodiments of the present invention that employ super-resolution in addition to filtering within the interpolation process are advantageous relative to many conventional image coding/decoding systems. Enhanced imaging is achieved without the use of super-resolution in post-processing. Further, by virtue of performing super-resolution as part of the coding (and/or decoding) process, greater flexibility of the video coding (and/or decoding) process is provided and more efficient and accurate motion estimation and motion compensation can be performed. This, in turn, when employed during motion compensation, serves to produce motion compensated reference frames having a close resemblance with the source frame 204.

Although in the above-described embodiments interpolation utilizing super-resolution as an additional option within the traditional interpolation process are envisioned as being performed on complete source frames, in other embodiments, it is also possible in some alternate embodiments to perform such operations upon sections/portions of the previously reconstructed frame(s), or upon general areas of interest within these frames. In some embodiments, super-resolution based interpolation is performed in relation to some but not all coding/decoding (e.g., in relation to certain source frames only) operations. Embodiments of the present invention are intended for applicability with a variety of image coding/decoding and processing standards and techniques including, for example, the MPEG-1, MPEG-2, MPEG-4, H.263, and H.264 standards, as well as additional subsequent versions of these standards and new standards.

It is specifically intended that the present invention not be limited to the embodiments and illustrations contained herein, but include modified forms of those embodiments including portions of the embodiments and combinations of elements of different embodiments as come within the scope of the following claims.

We claim:

1. A system for processing video imaging information, the system comprising:
a port for communicating with a communications channel;
a first processing portion coupled at least indirectly with the port and capable of coding or decoding residual error information;
a second processing portion coupled at least indirectly with the port and capable of coding or decoding motion vector information; and
a third processing portion that either generates the residual error information based upon input source frame information or generates output source frame information based at least indirectly upon the residual error information; and
a fourth processing portion configured to perform an interpolation process including a super-resolution operation to generate at least one output signal based upon previous frame information,
wherein the residual error information or output source frame information generated by the third processing portion is further based at least indirectly upon the motion vector information and the output signal.

2. The system of claim 1, wherein the interpolation process is capable of including both the super-resolution operation and a filtering operation, and further comprising:
making a determination that the fourth processing portion perform the super-resolution operation in addition to or in replacement of a filtering operation in performing the interpolation process.

3. The system of claim 1, wherein the output signal generated by the fourth processing portion is a reference frame based upon the previous frame information, and wherein the previous frame information includes information corresponding to a plurality of previous video frames that correspond to past versions of a source video frame.

4. The system of claim 1, wherein the system includes an encoder, and wherein the third processing portion performs a motion estimation operation based upon the input source frame information and the output signal so as to generate the motion vector information.

5. The system of claim 4, wherein the third processing portion also performs a motion compensation operation based upon the motion vector information and the output signal so as to generate motion compensated prediction frame information.

6. The system of claim 5, wherein the third processing portion also performs a difference operation to determine a difference between the input source frame information and the motion compensated prediction frame information so as to generate the residual error information.

7. The system of claim 1, wherein the system includes an encoder, and wherein each of the first processing portion and the second processing portion performs variable length coding.

8. The system of claim 7, wherein the first processing portion additionally performs at least one of a transformation operation, a quantization operation, and a variable length decoding operation.

9. The system of claim 1, wherein the system includes a decoder, and wherein the third processing portion performs a motion compensation operation to generate motion compensated prediction frame information based at least indirectly upon the motion vector information and the output signal.

10. The system of claim 9, wherein the third processing portion also performs an addition operation to determine a sum of the motion compensated reference frame information and a value based at least indirectly upon the residual error information, the sum being the output source frame information.

11. The system of claim 1, wherein the system is a codec device including both an encoder and a decoder.

12. The system of claim 1, wherein the system is capable of converting the video imaging information formatted in accordance with any one or more of the MPEG-1, MPEG-2, MPEG-3, MPEG-4, H.261, H.262, H.263 and H.264 standards.

13. An electronic device comprising:
a coder capable of compressing video imaging information for transmission via a communications channel, the video imaging information pertaining to a plurality of video source frames including a current source frame,
wherein the coder includes means for performing a super-resolution operation in relation to previous frame information representative of at least one of the video source frames occurring prior to the current source frame, the super-resolution operation being performed prior to at least some of the video imaging information corresponding to the current source frame being coded or decoded.

14. A method of processing video imaging information, the method comprising:
receiving input video imaging information pertaining to a plurality of source frames including a current source frame;
generating a reference frame based upon at least one previous frame corresponding to at least one of the source frames occurring prior to the current source frame; and
performing at least one operation based upon the reference frame and the current source frame to generate a motion vector and a motion compensated prediction frame;
wherein the generating of the reference frame includes an interpolation process that includes a super-resolution operation.

15. The method of claim 14, further comprising:
coding the motion vector and a residual error for transmission onto a communication channel, the residual error being generated based upon the current source frame and the motion compensated prediction frame,

16. The method of claim 14, further comprising repeating the generating, performing and coding for additional source frames subsequent to the current source frame, and wherein the coding includes at least one of a transformation, variable length coding, and quantization.

17. The method of claim 14, wherein the performing of the at least one operation includes the performing of both a motion estimation operation to generate the motion vector based upon the reference frame and the current source frame, and the performing of a motion compensation operation based upon the reference frame and the motion vector so as to generate the motion compensated prediction frame.

18. The method of claim 14, further comprising, prior to the generating of the reference frame:
making a determination to perform the super-resolution operation in addition to a filtering operation as portions of the interpolation process, rather than to perform merely the filtering operation.

19. A system for processing video imaging information, the system comprising:
a port for communicating with a communications channel;
a video encoder or decoder coupled at least indirectly with the port and capable of coding or decoding video information;
wherein the video encoder or decoder includes an interpolation processing portion that is employed in combination with at least one of a motion estimation portion and a motion compensation portion, and wherein the interpolation processing portion performs a super-resolution operation, whereby a motion compensated prediction frame is generated.

20. The system of claim 19, wherein the interpolation processing portion makes a determination to perform the super-resolution operation in replacement of or in addition to performing a filtering operation, and wherein the super-resolution operation allows for a resolution of one or more previously reconstructed frames to be increased.
